(19) United States
(12) Patent Application Publication
(10) Pub. No.: US 2026/0331086 A1
(43) Pub. Date: Oct. 22, 2026

(54) PIANO KEYBOARD

(71) Applicant: PICOSSI NOTACIÓN MUSICAL, S.L., Sevilla (ES)

(72) Inventor: Juan Manuel PICOSSI, Sevilla (ES)

(21) Appl. No.: 19/205,164

(22) Filed: May 12, 2025

(30) Foreign Application Priority Data
Apr. 16, 2025 (EP) 25171123.0

(51) Int. Cl. G10H 1/34

(52) U.S. Cl. CPC G10H 1/346

(57) ABSTRACT

Improved piano keyboard comprising: a first row comprising keys evenly distributed along a longitudinal direction; and a second row comprising keys evenly distributed along the longitudinal direction. The keys of the first and second rows all have the same width. The first and second rows are adjacent one another in a direction perpendicular to the longitudinal direction. The first and second rows are offset in the longitudinal direction a distance less than the width of a key. A tone of a note corresponding to each key uniformly increases key-by-key from the leftmost key to the rightmost key irrespective of whether the key belongs to the first or second row. The total number of keys is the same as in a conventional piano. The note of each key univocally corresponds to a note of a key in a conventional piano.

### CROSS-REFERENCE TO RELATED APPLICATIONS AND PRIORITY

This patent application claims priority from European Patent Application No. 25171123.0 filed Apr. 16, 2025. This patent application is herein incorporated by reference in its entirety.

### OBJECT OF THE INVENTION

The object of the invention is a piano keyboard having a new, more intuitive key distribution.

### PRIOR ART

Learning how to play the piano, or generally speaking any keyboard instrument, is extremely difficult and thus takes several years of practice. One of the reasons is that the distribution of the keys in the keyboard does not follow a logical, intuitive pattern.

Indeed, in a conventional piano keyboard, keys are arranged in groups of 7 white keys and 5black keys. A heptatonic scale was originally used, which only has 7 notes, corresponding to the 7 white keys. Later, the chromatic scale, which has 12 notes, was adopted. To incorporate the 5 additional notes, black keys were added, grouped into two blocks of 2 and 3 keys.

This irregular configuration of white and black keys means that there are numerous finger configurations for playing the different chords, which requires a significant learning effort. In addition to this, there are many types of chords: major, minor, diminished, augmented, seventh, and so on, up to almost 50. As an example of the difficulty: see this website with a chord calculator https://www.pianochord.org/.

Therefore, there is a need in this field for a more intuitive piano keyboard.

### BRIEF DESCRIPTION OF THE INVENTION

The present invention solves the aforementioned problem by means of an improved piano keyboard where the keys are evenly distributed according to a particularly useful key pattern. This new key pattern greatly reduces the number of hand positions needed to play the chords, thereby making piano playing much more intuitive and, therefore, easier to learn.

Further, the improved piano keyboard of the present invention is particularly well suited to be used in combination with the piano notation developed by the inventor of the present application in U.S. Pat. No. 11,081,093B1, the whole content of which is hereby introduced by reference.

The improved piano keyboard of the invention is therefore characterized by comprising the following features:
A first longitudinal row comprising a plurality of keys evenly distributed along the longitudinal direction. The keys can be of any type of conventional keys, including keys configured to actuate mechanical components, electronic components, or a combination of both.
A second longitudinal row comprising a plurality of keys evenly distributed along the longitudinal direction. The first and second rows are therefore parallel.

The first longitudinal row is intended to be the row closest to the person playing the piano. Correspondingly, the second longitudinal row is intended to be the row farthest from the person playing the piano. Thus, in the present document, the terms “right” and “left” must be interpreted with reference to a person playing the piano facing the first longitudinal row.

The keys of the first longitudinal row and the second longitudinal row all have the same longitudinal width. That is, all of the keys of this novel keyboard have the same width, in contrast to a conventional piano keyboard where the white keys are wider than the black keys. Note also that keys of each row are ones next to the others with no additional keys having different size between them, in contrast to a conventional piano where the black keys are “inserted” between the white keys. According to the present invention, both rows are formed by identical keys provided one after the other along the longitudinal direction.

Further, the first and second longitudinal rows are adjacent one another in a direction perpendicular to the longitudinal direction. Thus, a longitudinal side of the first row is adjacent longitudinal side of the second row, i.e. between them there is only a very small separation essentially intended to allow for the keys not to touch each other upon being pressed. For example, the separation between the first longitudinal row and the second longitudinal row could be between 1/10 and 1/50 of an inch.

The first and second longitudinal rows are offset in the longitudinal direction a distance less than the longitudinal width of a key. Taking the first longitudinal row as a reference, the second longitudinal row is offset towards the right or, more preferably, towards the left along the longitudinal direction. Preferably, the offset distance is half the width of a key.

In the keyboard of the invention, a tone of a note corresponding to each key uniformly increases key-by-key from the leftmost key to the rightmost key irrespective of whether the key belongs to the first longitudinal row or to the second longitudinal row. Taking into account that one row is offset a distance lower than the width of a key with respect to the other, the above feature means that to press all of the keys of the keyboard in a tone-ascending manner, one would start from the leftmost key of the keyboard and advance towards the right alternating a key of one of the row and a key of the other row. For example, if the second row is offset towards the left, then the first key would be the leftmost key of the second row, the next key would be the leftmost key of the first row, the next key would be the second key of the second row starting from the left, and so on. Again, this contrast the situation in a conventional piano, where in some occasions the next-tone key involves passing from white key to black key, while in other occasions the next-tone key requires passing from one white key to another white key.

Furthermore, in the keyboard of the present invention the total number of keys is the same as in a conventional piano, where the note of each key univocally corresponds to a note of a key in a conventional piano. Since a conventional piano normally has 88 keys, the keyboard of the invention normally also has 88 keys, and each of the 88 keys of the conventional piano has a corresponding key in the keyboard of the invention that emits a note having the same tone. In other words, the keyboard of the invention merely redistributes the keys of the conventional piano.

In a particularly preferred embodiment, the first longitudinal row has 44 keys and the second longitudinal row has 44 keys. Thus, the 88 keys of a conventional piano are present in the keyboard of the invention.

In another preferred embodiment of the invention, the keys of the first longitudinal row and the keys of the second longitudinal row are provided at the same horizontal plane. That is, the upper surface of all of the keys of the keyboard of the invention are contained in the same horizontal plane. This configuration contrasts the configuration of a conventional piano, where the black keys are provided in a higher position with respect to the white keys.

In an alternative preferred embodiment, the keys of the second longitudinal row are provided at a higher horizontal plane than the first longitudinal row. This feature could prove advantageous for allowing the keys of the second longitudinal row to be pressed more easily. Further embodiments of the present invention are directed to implementing the musical notation disclosed in U.S. Pat. No. 11,081,093B1, developed by the same inventor as the present invention.

In particular, in another preferred embodiment each key has a number between 1 and 12, the keys being distributed to form compact 12-key groups each corresponding to an octave. Further, each of the 12 keys in a group corresponding to one of the twelve notes in an octave are numbered from 1 to 12. The numbers increase with the note played by the corresponding key, such that the number in the keys of each group increase towards the right while alternating between one row and the other. This feature allows for the user to very easily and conveniently identify the keys corresponding to an octave.

In yet another preferred embodiment of the invention, the keys of each 12-key group have the same colour, the colour of the keys of a 12-key group being different than the colour of the keys of another 12-key group. Thus, each octave group formed by 12 keys not only can be easily identified by the numbers increasing from left to right, but also all of the keys of one of such octave groups have a particular colour. This feature makes the identification of each key straightforward.

In still another preferred embodiment, the leftmost key of the first longitudinal row, the two leftmost keys of the second longitudinal row, and the rightmost key of the first longitudinal row do not belong to any group.

### BRIEF DESCRIPTION OF THE FIGURES

The patent or application file contains at least one drawing executed in color. Copies of this patent or patent application publication with color drawings will be provided by the Office upon request and payment of the necessary fee.

FIG. 1 shows the keyboard of a conventional piano.

FIG. 2 shows the musical notation disclosed in U.S. Pat. No. 11,081,093B1 developed by the same inventor as the present invention.

FIG. 3 shows a piano keyboard according to the present invention.

FIGS. 4a and 4b respectively show the left portion and the right portion of a piano keyboard according to the present invention.

FIGS. 5a, 5b, and 5c show a chord formed by three consecutive notes in different positions of a piano keyboard according to the present invention.

FIGS. 6a, 6b and 6c show the same chords played in a piano keyboard according to the present invention.

### PREFERRED EMBODIMENT OF THE INVENTION

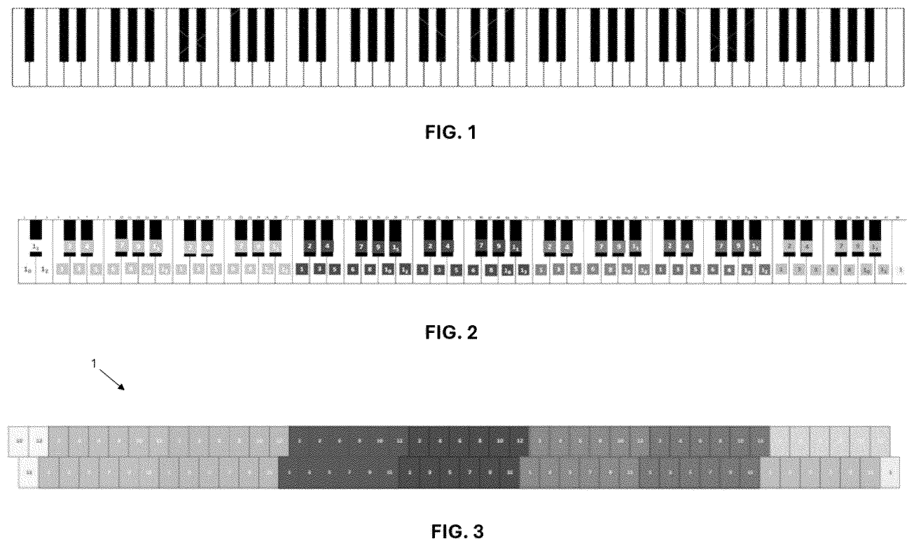

FIG. 1 shows a conventional piano keyboard formed by 88 keys: 52 white keys and 36 black keys. The black keys are inserted between adjacent white keys. However, not all pairs of white keys have a black key inserted between them. Rather, every two or three black keys, there is a pair of white keys lacking a black key between them. In consequence, upon playing a white key, to play a next note the user sometimes has to play an adjacent black key while other times he/she hast to play an adjacent white key. Similarly, when playing chords of, say, three keys, tone-consecutive chords require completely different hand positions.

In addition, all white and black keys have exactly the same aspect. Identifying each key is therefore very difficult for beginners.

FIG. 2 shows a conventional piano keyboard with stickers according to the notation developed by the inventor of the present invention disclosed in U.S. Pat. No. 11,081,093B1. This notation identifies each of the keys in an octave of the keyboard by a number from 1 to 12. Further, the stickers corresponding to all of the keys of an octave have the same colour. Thus, the notation of U.S. Pat. No. 11,081,093B1 provides an improvement whereby a user can more easily identify the keys.

Now, FIG. 3 shows a keyboard (1) according to the present invention that provides yet a further improvement in that the keys are more uniformly distributed, thereby reducing the number of hand positions required to play the chords. Further, this keyboard distribution is advantageous because the location of each key is more intuitively perceived by the user.

The keyboard (1) of this exemplary embodiment comprises 88 keys, exactly the same number of keys of a conventional piano such as that shown in FIG. 1. Each of the 88 keys of the exemplary embodiment keyboard (1) plays the same note of a particular key of the conventional piano. Thus, the keyboard (1) comprises exactly the same notes of a conventional piano, although differently distributed.

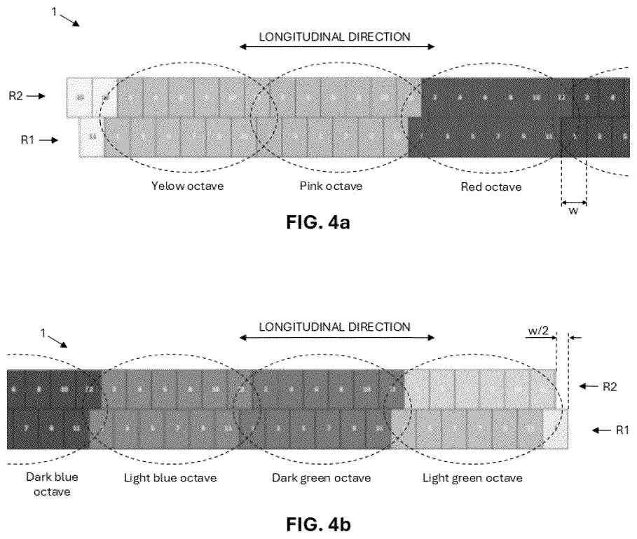

As shown in FIGS. 4a and 4b, the keyboard (1) comprises a first row (R1) and a second row (R2), where both rows are oriented in parallel along a longitudinal direction and adjacent one to the other. The first row (R1) is intended to be positioned adjacent the user, while the second row (R1) is farther from the user. All of the keys of both the first row (R1) and the second row (R2) have a rectangular shape having the same width in the longitudinal direction. In this embodiment, all of the keys of both the first row (R1) and the second row (R2) also have the same length in a direction perpendicular to the longitudinal direction. The second row (R2) is offset towards the left with respect to the first row (R1) a distance of half a key width.

Further, the keys of the keyboard are organized in groups, each corresponding to the twelve keys of an octave. The twelve keys of an octave are numbered from left to right starting from the leftmost key of the group, which belongs to the first row (R1), and finishing with the rightmost key of the group, which belongs to the second row (R2). Consecutive numbers therefore alternate between the first row (R1) and the second row (R2).

The keyboard therefore comprises 7 of these groups. Four keys do not belong to any of these groups, in particular the leftmost key in the first row (R1), the two leftmost keys in the second row (R2), and the rightmost key in the first row (R1).

The groups are further identified ones from the others by means of colours. All of the keys of a particular group have a particular colour that is different from the colour of the keys of a different group. In this exemplary embodiment, starting from the left of the keyboard, the first group is yellow, the next group is pink, then red, dark blue, light blue, dark green, and finally light green. Providing the keys with colours according to this pattern enables the user to very fast and intuitively recognize each individual key, and therefore each individual note.

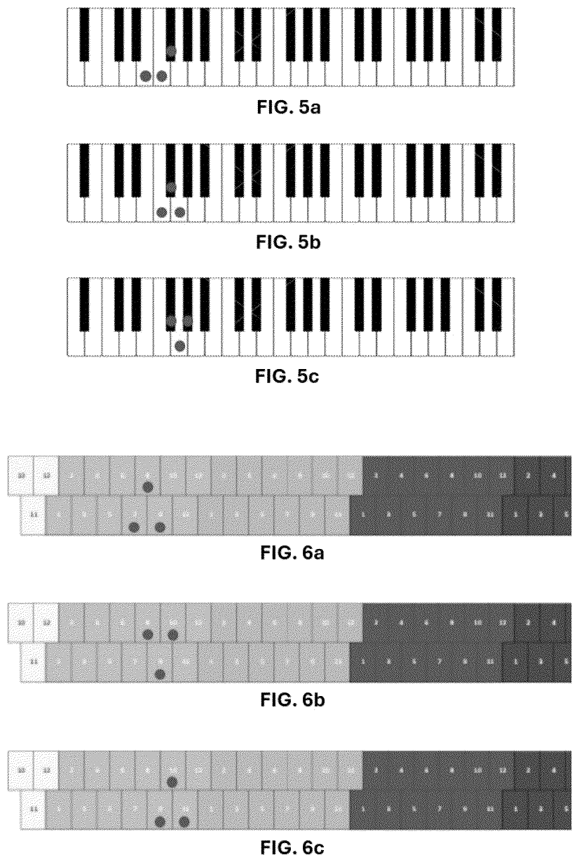

FIGS. 5 and 6 show examples of chords played with a conventional piano (FIG. 5) and with the keyboard of the invention (FIG. 6).

In particular, FIGS. 5a-5c show a simple chord formed by three consecutive notes in different positions of the keyboard. In FIG. 5a, a hand position is required whereby two fingers press two white keys and one finger further to the right presses a black key. Now, upon advancing the chord just one key towards the right, then the hand position changes completely: two fingers still press two white keys, but this time the finger pressing the black key must be between the two fingers pressing the white keys. And upon advancing the chord yet one key towards the right, the hand position again changes: two fingers press two black keys, and a finger between the previous two presses a white key. This is just an example, but it is easy to see how staggering the variety of hand positions required to play more complex chords is. Further, note also that playing similar chords, i.e. chords involving adjacent or near-adjacent keys, require very different hand positions.

FIGS. 6a-6c show the same chords played in the keyboard (1) of the invention. Note that for a chord involving three consecutive notes there are only two hand positions. In the first position shown in FIG. 6a, two fingers press two keys in the first row (R1) and one finger presses a key in the second row (R2) placed between the two aforementioned keys. Upon advancing the chord one note, in the second position shown in FIG. 6b two fingers press two keys in the second row (R2) and one finger presses a key in the first row (R1) placed between the two aforementioned keys. Now, upon advancing the chord yet one note, the user only needs to repeat the first position, and so on for set consecutive chords. Again, while this is only an example, it is easy to see how the number of hand positions required to play any number of chords with the keyboard of the present invention is substantially lower in comparison with those required when using a conventional piano.

1. Improved piano keyboard (1) characterized by comprising:
a first longitudinal row (R1) comprising a plurality of keys evenly distributed along the longitudinal direction; and
a second longitudinal row (R2) comprising a plurality of keys evenly distributed along the longitudinal direction,
where the keys of the first longitudinal row (R1) and the second longitudinal row (R2) all have the same longitudinal width (w),
where the first and second longitudinal rows (R1, R2) are adjacent one another in a direction perpendicular to the longitudinal direction,
where the first and second longitudinal rows (R1, R2) are offset in the longitudinal direction a distance less than the longitudinal width (w) of a key,
where a tone of a note corresponding to each key uniformly increases key-by-key from the leftmost key to the rightmost key irrespective of whether the key belongs to the first longitudinal row (R1) or to the second longitudinal row (R2),
where the total number of keys is the same as in a conventional piano, and where the note of each key univocally corresponds to a note of a key in a conventional piano.

2. Improved piano keyboard (1) according to claim 1, where the first and second longitudinal rows (R1, R2) are offset in the longitudinal direction a distance of half the longitudinal width (w) of a key.

3. Improved piano keyboard (1) according to claim 2, where the second longitudinal row (R2) is offset to the left with respect to the first longitudinal row (R1).

4. Improved piano keyboard (1) according to claim 1, where the first longitudinal row (R1) has 44 keys and the second longitudinal row (R2) has 44 keys.

5. Improved piano keyboard (1) according to claim 1, where the keys of the first longitudinal row (R1) and the keys of the second longitudinal row (R2) are provided at the same horizontal plane.

6. Improved piano keyboard (1) according to claim 1, where the keys of the second longitudinal row (R2) are provided at a higher horizontal plane than the first longitudinal row (R1).

7. Improved piano keyboard (1) according to claim 1, where each key has a number between 1 and 12, the keys being distributed to form compact 12-key groups each corresponding to an octave, where each of the 12 keys in a group corresponding to one of the twelve notes in an octave are numbered from 1 to 12.

8. Improved piano keyboard (1) according to claim 7, where the keys of each 12-key group have the same colour, the colour of the keys of a 12-key group being different than the colour of the keys of another 12-key group.

9. Improved piano keyboard (1) according to claim 7, where the leftmost key of the first longitudinal row (R1), the two leftmost keys of the second longitudinal row (R2), and the rightmost key of the first longitudinal row (R1) do not belong to any group.
